(19) United States
(12) Patent Application Publication
(10) Pub. No.: US 2026/0259457 A1
(43) Pub. Date: Sep. 3, 2026

(54) DISPLAY DEVICE INCLUDING MULTILAYER NONPOLAR LIQUID AND METHOD OF MANUFACTURING THE SAME

(71) Applicant: Korea Electronics Technology Institute, Seongnam-si (KR)

(72) Inventor: Soon Hyung KWON, Seongnam-si (KR)

(21) Appl. No.: 19/310,735

(22) Filed: Aug. 26, 2025

(30) Foreign Application Priority Data
Feb. 28, 2025 (KR) 10-2025-0026959

(51) Int. Cl. G02F 1/1339; G02F 1/1333; G02F 1/1343

(52) U.S. Cl. CPC G02F 1/13398; G02F 1/133331; G02F 1/134309

(57) ABSTRACT

Proposed are a display device including a multilayer nonpolar liquid and a method of manufacturing the same. The display device may include a display panel, a cover window at least partially in contact with the display panel, and a multilayer nonpolar liquid layer positioned between the display panel and the cover window. The multilayer nonpolar liquid layer may include a gap control layer positioned between the display panel and the cover window and having a film shape, a first nonpolar liquid positioned between the display panel and the gap control layer, and a second nonpolar liquid positioned between the gap control layer and the cover window.

### CROSS REFERENCE TO RELATED APPLICATION

The present application claims priority to Korean Patent Application No. 10-2025-0026959, filed February 28, 2025, the entire contents of which is incorporated herein for all purposes by this reference.

### BACKGROUND

### Technical Field

The present disclosure relates to a display device including a multilayer nonpolar liquid and a method of manufacturing the same.

### Description of Related Technology

Display devices employ various types of display technologies, such as a liquid crystal display (LCD), an organic light emitting diode (OLED), a micro-LED, and an electrophoretic display. Such a display device includes a display panel configured to display information and a cover window coupled to the display panel to protect the display panel. An air gap may be defined between the display panel and the cover window. A difference in refractive index between the cover window, the air gap, and the display panel may cause visibility degradation.

### SUMMARY

One aspect is a display device including a multilayer nonpolar liquid between a display panel and a cover window or between a display panel including a protruding portion and a cover window, and a method of manufacturing the same.

Another aspect is a display device including a multilayer nonpolar liquid, in which at least one gap control layer is disposed between the display panel and the cover window and nonpolar liquid layers are formed between the display panel, the gap control layer, and the cover window, and a method of manufacturing the same.

Another aspect is a display device including a multilayer nonpolar liquid that includes a display panel, a cover window at least partially in contact with the display panel, and a multilayer nonpolar liquid layer positioned between the display panel and the cover window. The multilayer nonpolar liquid layer includes a gap control layer positioned between the display panel and the cover window and having a film shape, a first nonpolar liquid positioned between the display panel and the gap control layer, and a second nonpolar liquid positioned between the gap control layer and the cover window.

According to an embodiment, the multilayer nonpolar liquid layer may further include one or more additional gap control layers and one or more additional nonpolar liquids stacked between the second nonpolar liquid and the cover window.

According to an embodiment, the gap control layer may be formed of an oleophilic material having compatibility with the first nonpolar liquid and the second nonpolar liquid.

According to an embodiment, the first nonpolar liquid and the second nonpolar liquid may be connected to each other beyond an edge of the gap control layer.

According to an embodiment, the gap control layer may be configured to exhibit a color, and the color of the gap control layer may be visually perceived in a state of being blended with a color displayed on the display panel.

According to an embodiment, the gap control layer may include a pattern, and the pattern may be visually perceived in a state of overlapping an image displayed on the display panel.

According to an embodiment, the display panel may include a protruding portion formed on an upper surface thereof, the cover window may be in contact with the protruding portion, and the gap control layer may be positioned between the display panel and the cover window in a region other than the protruding portion.

According to an embodiment, the protruding portion may contain a circuit configured to operate the display panel.

According to an embodiment, the display device including a multilayer nonpolar liquid may further include an oleophilic region formed by coating an oleophilic material, having compatibility with the first nonpolar liquid and the second nonpolar liquid, on an upper surface of the display panel and a lower surface of the cover window.

According to an embodiment, the display device including a multilayer nonpolar liquid may further include a sealing portion positioned between the display panel and the cover window so as to surround the multilayer nonpolar liquid layer.

According to an embodiment, the display panel may include a lower substrate, a lower electrode layer formed on the lower substrate, a display layer formed on the lower electrode layer and configured to display information through movement of electrophoretic particles, an upper electrode layer formed on the display layer, and an upper substrate formed on the upper electrode layer.

In accordance with another aspect of the present disclosure, a method of manufacturing a display device including a multilayer nonpolar liquid includes applying a first nonpolar liquid to an upper surface of a display panel, placing a gap control layer on the first nonpolar liquid, applying a second nonpolar liquid onto the gap control layer, and placing a cover window on the second nonpolar liquid.

According to an embodiment, the method may further include, after applying the second nonpolar liquid, placing an additional gap control layer on the second nonpolar liquid and applying an additional nonpolar liquid onto the additional gap control layer. Placing the additional gap control layer and applying the additional nonpolar liquid may be alternately performed one or more times.

According to an embodiment, the method may further include, before applying the first nonpolar liquid to the upper surface of the display panel, coating an oleophilic material on the upper surface of the display panel, and, before placing the cover window, coating an oleophilic material on a lower surface of the cover window.

The features and advantages of the present disclosure will become more obvious from the following detailed description provided with reference to the accompanying drawings.

Before explaining embodiments of the present disclosure, it is to be understood that the phraseology and terminology used in the following specification and appended claims should not be construed as limited to general and dictionary meanings but be construed as having meanings and concepts according to the spirit of the present disclosure on the basis of the principle that the inventor is permitted to define appropriate terms for the best explanation.

### BRIEF DESCRIPTION OF THE DRAWINGS

The above and other aspects, features, and other advantages of the present disclosure will be more clearly understood from the following detailed description taken in conjunction with the accompanying drawings.

FIG. 1 is a view showing a display device including a multilayer nonpolar liquid according to an embodiment.

FIG. 2 is an exploded perspective view of the display device including a multilayer nonpolar liquid according to the embodiment.

FIG. 3 is a cross-sectional view taken along line A–A' in FIG. 1.

FIG. 4 is a view showing a display device according to a comparative example in which a gap control layer is not provided.

FIG. 5 is a cross-sectional view of the display device including a multilayer nonpolar liquid according to the embodiment, which includes a plurality of gap control layers.

FIG. 6 is a cross-sectional view of the display device including a multilayer nonpolar liquid according to the embodiment, which includes a gap control layer having a small area.

FIG. 7 is a cross-sectional view of the display device including a multilayer nonpolar liquid according to the embodiment, in which a protruding portion is not present on a display panel.

FIG. 8 is an exploded perspective view of the display device including a multilayer nonpolar liquid according to the embodiment, in which the gap control layer has a predetermined color or pattern.

FIG. 9 is an exploded perspective view of the display device including a multilayer nonpolar liquid according to the embodiment, which further includes an oleophilic region.

FIG. 10 is an exploded perspective view of the display device including a multilayer nonpolar liquid according to the embodiment, which further includes a sealing portion.

FIG. 11 is a cross-sectional view of the display device including a multilayer nonpolar liquid shown in FIG. 10.

FIG. 12 is a view showing a method of manufacturing the display device including a multilayer nonpolar liquid according to an embodiment.

FIG. 13 is a view showing a method of manufacturing the display device including a multilayer nonpolar liquid according to an embodiment, which further includes an oleophilic region.

### DETAILED DESCRIPTION

Hereinafter, exemplary embodiments of the present disclosure will be described in detail with reference to the accompanying drawings. However, the exemplary embodiments of the present disclosure to be described below are provided by way of example, and the present disclosure is not limited to the exemplary embodiments set forth herein.

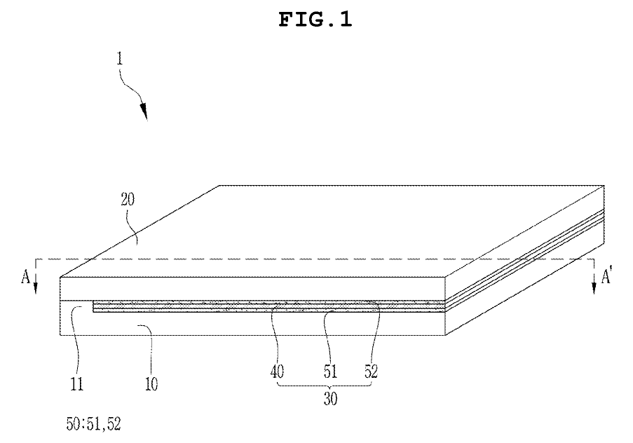

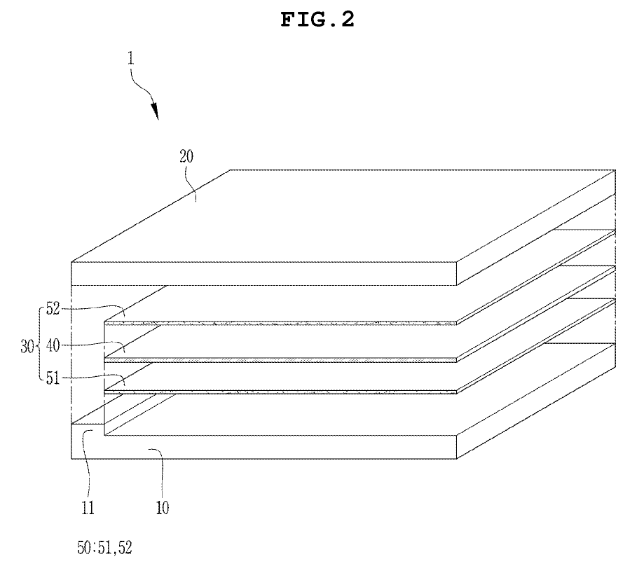

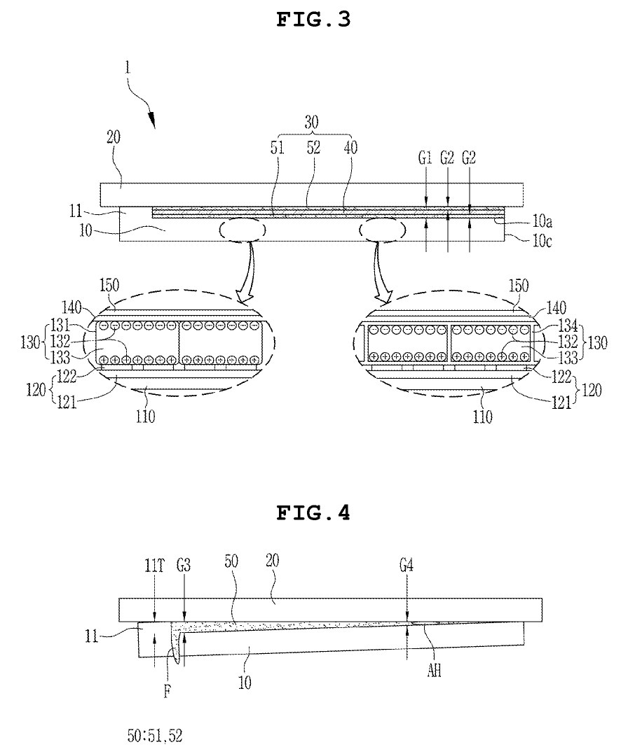

FIG. 1 is a view showing a display device 1 including a multilayer nonpolar liquid according to an embodiment. FIG. 2 is an exploded perspective view of the display device 1 including a multilayer nonpolar liquid according to the embodiment. FIG. 3 is a cross-sectional view taken along line A–A' in FIG. 1.

The display device 1 including a multilayer nonpolar liquid may include a display panel 10, a cover window 20 at least partially in contact with the display panel 10, and a multilayer nonpolar liquid layer 30 disposed between the display panel 10 and the cover window 20. The multilayer nonpolar liquid layer 30 may include a gap control layer 40 having a film shape and disposed between the display panel 10 and the cover window 20, a first nonpolar liquid 51 disposed between the display panel 10 and the gap control layer 40, and a second nonpolar liquid 52 disposed between the gap control layer 40 and the cover window 20.

The display panel 10 may display letters, numerals, symbols, images, colors, videos, or other types of information. The display panel 10 may include a light reflective type of panel such as an electrophoretic display, an electrochromic display, an electrowetting display, a toner display, or a reflective liquid crystal display, and may also include a light emissive type of display such as an LCD, a PDP, an OLED, an LED, or a QD-LED.

The cover window 20 may be positioned at an outermost portion of the display device 1 in order to protect the display panel 10. Information may be displayed through an upper surface 20a of the cover window 20. The cover window 20 may include a glass plate or a synthetic resin plate that protects the display panel 10. The cover window 20 may prevent the display panel 10 from being directly impacted by external force. The cover window 20 may also prevent moisture or contaminants from directly reaching the display panel 10.

The multilayer nonpolar liquid layer 30 may be disposed between the display panel 10 and the cover window 20. The multilayer nonpolar liquid layer 30 may include a gap control layer 40, a first nonpolar liquid 51 positioned on a lower surface of the gap control layer 40, and a second nonpolar liquid 52 positioned on an upper surface of the gap control layer 40. In the multilayer nonpolar liquid layer 30, the term “multilayer” may refer to a configuration in which a nonpolar liquid 50 is formed as layers on both an upper side and a lower side of the gap control layer 40. The nonpolar liquid 50 may be classified into a first nonpolar liquid 51 and a second nonpolar liquid 52 depending on the positions thereof. The multilayer nonpolar liquid layer 30 may include two or more gap control layers 40 and three or more layers of the nonpolar liquid 50. The first nonpolar liquid 51 and the second nonpolar liquid 52 may be formed of the same material. Alternatively, the first nonpolar liquid 51 and the second nonpolar liquid 52 may be formed of different materials.

The gap control layer 40 may be a thin film disposed in a gap G1 defined between the display panel 10 and the cover window 20. The gap control layer 40 may be formed as a thin film or a thin membrane. The gap control layer 40 may be formed of a transparent material. Accordingly, even when the gap control layer 40 is positioned between the display panel 10 and the cover window 20, it may not obstruct a user from perceiving information displayed on the display panel 10.

An upper surface 10a of the display panel 10 or a lower surface of the cover window 20 may not be flat. In such a case, it may be difficult for the nonpolar liquid 50 to be adhered between the display panel 10 and the cover window 20. This is because an air layer may be formed in a non-flat portion of the display panel 10 or the cover window 20. The gap control layer 40 may prevent generation of a large gap G1 when the display panel 10 and the cover window 20 come into contact. The gap control layer 40 may be disposed in a relatively concave region within the gap G1 between the display panel 10 and the cover window 20.

For example, a protruding portion 11 may be formed on the upper surface of the display panel 10, and the cover window 20 may be in contact with the protruding portion 11. The gap control layer 40 may be positioned between the display panel 10 and the cover window 20 in a region other than the protruding portion 11. The upper surface 10a of the display panel 10 may be irregularly processed during the process of manufacturing the display panel 10, or a portion of a resin may protrude from the upper surface 10a of the display panel 10 during the process of molding a side surface of the display panel 10, whereby the protruding portion 11 may be formed. The protruding portion 11 may contain a circuit for operating the display panel 10. In the process of forming an electrode pattern for operating the display panel 10, a circuit may be formed to be higher than the upper surface 10a of the display panel 10. As described above, the protruding portion 11 may be formed in various structures due to various causes. The gap control layer 40 may be positioned in a gap defined between the display panel 10 and the cover window 20 due to the protruding portion 11. The gap control layer 40 may divide the gap G1 between the display panel 10 and the cover window 20 into a small gap G2 between the display panel 10 and the gap control layer 40 and a small gap G2 between the gap control layer 40 and the cover window 20. When the nonpolar liquid 50 is injected into the small gap G2 divided by the gap control layer 40, the nonpolar liquid 50 may be stably positioned in a desired region without generating air bubbles.

The nonpolar liquid 50 may be positioned between the cover window 20 and the display panel 10. The nonpolar liquid 50 may be a liquid that is not soluble in water and has no polarity. The nonpolar liquid 50 may include hexane, benzene, toluene, chloroform, or various oils. The nonpolar liquid 50 may include a first nonpolar liquid 51 positioned between the display panel 10 and the gap control layer 40 and a second nonpolar liquid 52 positioned between the gap control layer 40 and the cover window 20. The first nonpolar liquid 51 and the second nonpolar liquid 52 are both the nonpolar liquid 50 and may have the same composition. When the gap G2 between the display panel 10 and the gap control layer 40 and the gap G2 between the gap control layer 40 and the cover window 20 are very small, forces such as capillary action, a pressure difference between the gap G2 and an external space, and surface tension between molecules of the nonpolar liquid 50 may act on the nonpolar liquid 50. Accordingly, the nonpolar liquid 50 may not leak out of the region between the display panel 10 and the gap control layer 40 or out of the region between the gap control layer 40 and the cover window 20. The gap G1 between the display panel 10 and the cover window 20 may be excessively large due to the protruding portion 11. The gap control layer 40 may divide the gap G1 into a plurality of small gaps G2. The size of each of the small gaps G2 may be small enough to prevent the nonpolar liquid 50 from leaking out of the region between the display panel 10 and the gap control layer 40 or out of the region between the gap control layer 40 and the cover window 20 due to capillary action, pressure difference, or surface tension.

The cover window 20, the display panel 10, and an air layer may have different refractive indices. When an air layer is present between the cover window 20 and the display panel 10, visibility may be degraded due to a difference in refractive index. In the display device 1 including a multilayer nonpolar liquid according to the embodiment, the gap control layer 40 and the nonpolar liquid 50 may be positioned between the cover window 20 and the display panel 10 in order to reduce the difference in refractive index between the cover window 20 and the display panel 10, thereby improving visibility. The nonpolar liquid 50 may have a refractive index between the refractive index of the display panel 10 and the refractive index of the cover window 20.

In the display device 1 including a multilayer nonpolar liquid, the nonpolar liquid 50 is positioned between the display panel 10, the gap control layer 40, and the cover window 20 using forces such as capillary action, pressure difference, and surface tension. The side surface of the nonpolar liquid 50 is exposed. In this configuration, the side surface of the nonpolar liquid 50 refers to a surface that is oriented in the same direction as the side surface of the cover window 20 and the side surface 10c of the display panel 10.

The gap control layer 40 may be formed of an oleophilic material that is compatible with the nonpolar liquid 50. The nonpolar liquid 50 may be subject to relatively strong intermolecular attraction with the gap control layer 40 formed of an oleophilic material. Accordingly, it may be possible to prevent the nonpolar liquid 50 from leaking out of a prescribed region to an external area in which the gap control layer 40 is not present. It may also be stated that the gap control layer 40 is formed of a material having high wettability with the nonpolar liquid 50.

The display panel 10 may be an electrophoretic display panel. The display panel 10 may include a lower substrate 110, a lower electrode layer 120 formed on the lower substrate 110, a display layer 130 formed on the lower electrode layer 120 and configured to display information through movement of electrophoretic particles 132a and 132b, an upper electrode layer 140 formed on the display layer 130, and an upper substrate 150 formed on the upper electrode layer 140.

The lower substrate 110 may support the display panel 10.

The lower electrode layer 120 may be formed on the lower substrate 110. The lower electrode layer 120 may include a signal transmission layer 121 and a plurality of lower electrodes 122 formed on an upper side of the signal transmission layer 121. The signal transmission layer 121 may transmit an electrical signal to each of the plurality of lower electrodes 122. One lower electrode 122 or a plurality of lower electrodes 122 may operate as a pixel.

The display layer 130 may include a capsule structure 131 or a partition wall structure 134 therein. The capsule structure 131 may contain a plurality of particles 132a and 132b that represent colors and a fluid 133 in which the particles 132a and 132b are movable. The particles 132a and 132b may have a negative or positive electric charge. The particles 132a and 132b may move in response to an electric field generated between the upper electrode and the lower electrodes 122. If the first particles 132a or the second particles 132b move toward the upper substrate 150 according to the direction of the electric field, the colors of the particles 132a or 132b that have moved toward the upper substrate 150 may be displayed to the outside.

The partition wall structure 134 may form a plurality of compartments that contain a plurality of particles 132a and 132b and a fluid 133. The partition wall structure 134 may alternatively be formed in a cup-shaped structure. The fluid 133 and the plurality of particles 132a and 132b may be contained in the plurality of compartments formed by the partition wall structure 134.

The upper electrode layer 140 may be formed on an upper side of the display layer 130. The upper electrode layer 140 may be formed as a single electrode. Even though the upper electrode layer 140 is formed as a single electrode, because the lower electrode layer 120 includes the plurality of lower electrodes 122, the direction of the electric field in each region may be varied depending on the electrical signal applied to each of the lower electrodes 122. The upper electrode layer 140 may be formed of a material that is transparent in the visible spectrum. In some cases, the upper electrode layer 140 may be formed of a material that is transparent in various wavelength bands.

The upper substrate 150 may be formed on the upper electrode layer 140. The upper substrate 150 may be formed of a transparent material. The upper substrate 150 may protect and electrically insulate the upper electrode layer 140.

The display panel 10 may further include an insulating layer or an adhesive layer in addition to the lower substrate 110, the lower electrode layer 120, the display layer 130, the upper electrode layer 140, and the upper substrate 150.

When the display panel 10 employs a display type other than the electrophoretic display, the display panel 10 may further include an emission layer, a light diffusion layer, and other necessary components.

FIG. 4 is a view showing a display device according to a comparative example in which the gap control layer 40 is not provided.

In the display device shown in FIG. 4, if a protruding portion 11 is present on the display panel 10, a gap G1 is defined between a cover window 20 and a display panel 10. The cover window 20 may be in contact with the protruding portion 11 of the display panel 10 and may also be in contact with an end of the display panel 10 at which the protruding portion 11 is not formed. Accordingly, due to gaps G3 and G4 having different sizes between the display panel 10 and the cover window 20, a distance between the display panel 10 and the cover window 20 may not be uniform. Therefore, when a nonpolar liquid 50 is injected into the gaps G3 and G4, a refractive index may be distorted because the thickness of the nonpolar liquid 50 is not uniform between the display panel 10 and the cover window 20. Further, an air bubble AH may be generated in the gap G4. Alternatively, if the height 11T of the protruding portion 11 is large, the nonpolar liquid 50 may flow out of the region between the display panel 10 and the cover window 20. If the height 11T of the protruding portion 11 increases, the size of the gap G3 between the display panel 10 and the cover window 20 may also increase. If the size of the gap G3 is large, capillary action, pressure difference, and intermolecular attraction acting on the nonpolar liquid 50 may not be sufficient to retain the nonpolar liquid 50 at a prescribed position.

In contrast, in the display device 1 including a multilayer nonpolar liquid according to the embodiment shown in FIGS. 1 to 3, the gap control layer 40 may be positioned in the region in which the protruding portion 11 is not present although the cover window 20 is in contact with the protruding portion 11. Accordingly, in the region in which the protruding portion 11 is not present, the gap control layer 40 may maintain a uniform distance between the cover window 20 and the display panel 10. If the height of the protruding portion 11 is large, the gap control layer 40 may divide the gap G1 between the display panel 10 and the cover window 20 into a plurality of small gaps G2. Therefore, the nonpolar liquid 50 injected into the small gaps G2 may be subject to sufficient capillary action, pressure difference, and intermolecular attraction to be retained at a prescribed position. Further, the gap control layer 40 may allow the overall thickness of the gap G1 between the display panel 10 and the cover window 20 to remain uniform. As a result, the possibility of air bubbles (e.g., AH in FIG. 4) being present within the nonpolar liquid 50 may be minimized. Furthermore, because the overall thickness of the gap G1 is kept uniform, visibility may be improved.

As described above, since the gap control layer 40 and the nonpolar liquid 50 are disposed between the non-flat upper surface of the display panel 10 and the non-flat lower surface of the cover window 20, no air bubbles may be generated within the nonpolar liquid 50, and visibility may be improved.

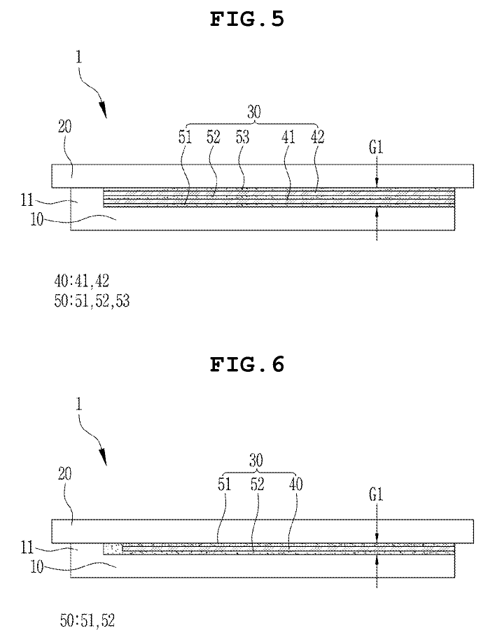

FIG. 5 is a cross-sectional view of the display device 1 including a multilayer nonpolar liquid according to the embodiment, which includes a plurality of gap control layers 40.

The multilayer nonpolar liquid layer 30 may further include an additional gap control layer and an additional nonpolar liquid stacked between the second nonpolar liquid 52 and the cover window 20. The multilayer nonpolar liquid layer 30 may include one or more additional gap control layers and one or more additional nonpolar liquids.

For example, two gap control layers 40 may be positioned between the display panel 10 and the cover window 20, a first nonpolar liquid 51 may be positioned between the display panel 10 and a first gap control layer 41, a second nonpolar liquid 52 may be positioned between the first gap control layer 41 and a second gap control layer 42, and a third nonpolar liquid 53 may be positioned between the second gap control layer 42 and the cover window 20. In this case, the second gap control layer 42 may be referred to as an additional gap control layer, and the third nonpolar liquid 53 may be referred to as an additional nonpolar liquid.

The number of additional gap control layers and the number of additional nonpolar liquids in the multilayer nonpolar liquid layer 30 may be varied depending on the size of the gap G1 between the display panel 10 and the cover window 20. If the size of the gap is large, a relatively great number of additional gap control layers may be required, and if the size of the gap is small, a relatively small number of additional gap control layers may be required. As the number of additional gap control layers increases, the gap may be divided into a greater number of smaller gaps G2. Accordingly, even if the size of the gap is large, the distance between the display panel 10 and the cover window 20 may be kept uniform, and the nonpolar liquid 50 may be stably retained at a prescribed position without leaking.

FIG. 6 is a cross-sectional view of the display device 1 including a multilayer nonpolar liquid according to the embodiment, which includes a gap control layer 40 having a small area.

The gap control layer 40 may be formed to have a smaller area than the region in which the nonpolar liquid 50 is positioned, and the first nonpolar liquid 51 and the second nonpolar liquid 52 may be connected to each other beyond the edge of the gap control layer 40.

The configuration in which the gap control layer 40 has a small area is a configuration in which the area of the gap control layer 40 is less than that of the region in which the nonpolar liquid 50 is positioned. When the area of the gap control layer 40 is small, the gap control layer 40 may float within the nonpolar liquid 50. The first nonpolar liquid 51 and the second nonpolar liquid 52, which are positioned on the lower surface and the upper surface of the gap control layer 40, may be connected to each other beyond the edge of the gap control layer 40. Even in such a structure, the area of the gap control layer 40 may be greater than the size of the active area of the display panel 10. Accordingly, the visibility of the display panel 10 in this structure may not differ from that in the structure described with reference to FIGS. 1 to 3.

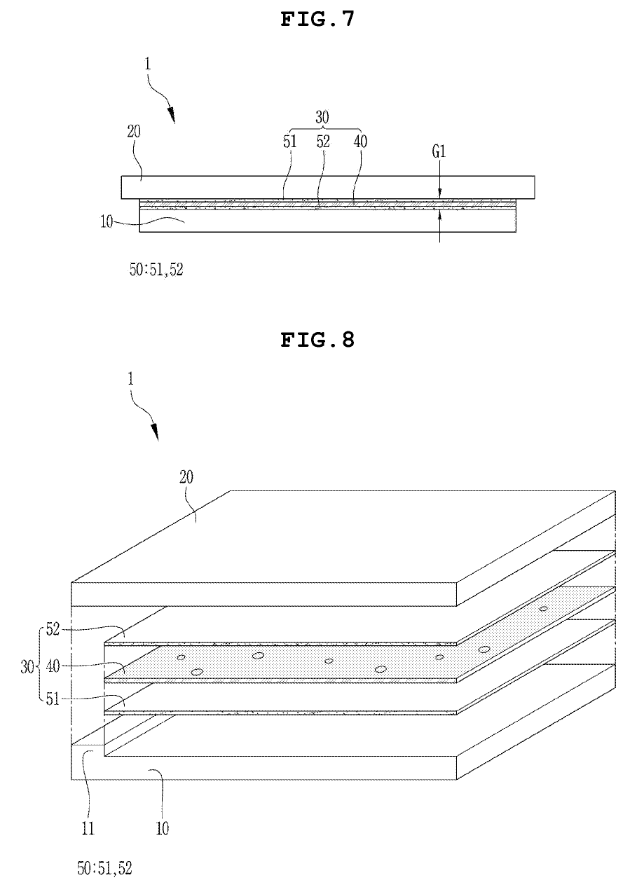

FIG. 7 is a cross-sectional view of the display device 1 including a multilayer nonpolar liquid according to the embodiment, in which the protruding portion 11 is not present on the display panel 10.

The protruding portion 11 may not be present on the upper surface 10a of the display panel 10. Even in such a case, the gap control layer 40 may be positioned in the gap G1, and the first nonpolar liquid 51 and the second nonpolar liquid 52 may be positioned on the lower surface and the upper surface of the gap control layer 40. The size of the gap G1 between the display panel 10 and the cover window 20 may be varied depending on the design of the display device. When the size of the gap is large, it may be possible to prevent leakage of the nonpolar liquid 50 out of the gap using the structure in which one or more gap control layers 40 are positioned in the gap and a plurality of layers of the nonpolar liquid 40 is formed. The gap control layer 40 formed of an oleophilic material may retain the nonpolar liquid 50 within a prescribed region. Accordingly, the nonpolar liquid 50 injected into the gap may be more stable.

FIG. 8 is an exploded perspective view of the display device 1 including a multilayer nonpolar liquid according to the embodiment, in which the gap control layer 40 has a predetermined color or pattern.

The gap control layer 40 may be configured to exhibit a color. The color of the gap control layer 40 may be blended with the color displayed on the display panel 10, and the resulting blended color may be visually perceived by the user. The gap control layer 40 may exhibit a specific color. For example, the gap control layer 40 may have a color such as blue, green, or red. Information displayed on the display panel 10 may pass through the gap control layer 40 and be visually perceived by the user in a state in which the displayed color is blended with the color of the gap control layer 40. The color of the gap control layer 40 may be used for decorative purposes or for filtering a specific color.

The gap control layer 40 may include a pattern. The pattern of the gap control layer 40 may overlap an image displayed on the display panel 10, and the result of the overlapping may be visually perceived by the user. The gap control layer 40 may include a specific pattern. For example, the gap control layer 40 may include a pattern such as a polygon, a circle, a droplet, an animal, or an object. Information displayed on the display panel 10 may be visually perceived by the user in a state of overlapping the pattern of the gap control layer 40. The pattern of the gap control layer 40 may be used for decorative purposes or for any desired function.

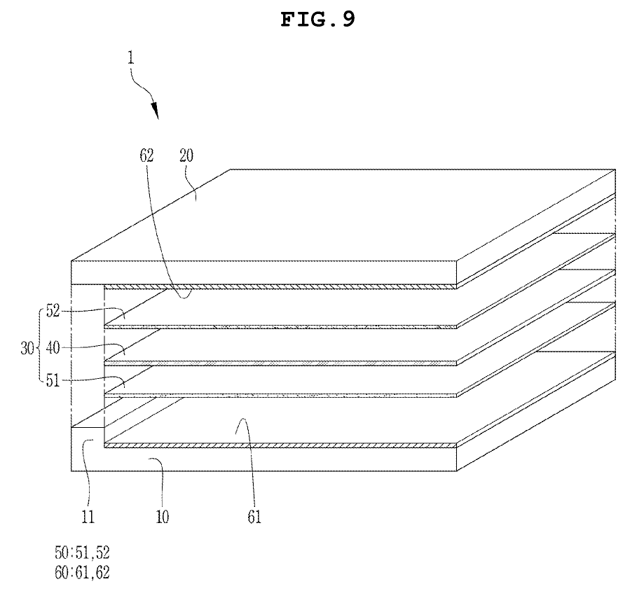

FIG. 9 is an exploded perspective view of the display device 1 including a multilayer nonpolar liquid according to the embodiment, which further includes an oleophilic region 60.

The display device 1 including a multilayer nonpolar liquid may further include an oleophilic region 60 formed by coating an oleophilic material, which is compatible with the nonpolar liquid 50, on the upper surface 10a of the display panel 10 and the lower surface of the cover window 20. The oleophilic region 60 may be formed of an oleophilic material. The oleophilic region 60 may be formed to have the same size as the region in which the nonpolar liquid 50 is positioned. The oleophilic region 60 may include a first oleophilic region 61 formed on the upper surface of the display panel 10 and a second oleophilic region 62 formed on the lower surface of the cover window 20. When the oleophilic region 60 is formed, the nonpolar liquid 50 may be more effectively adhered to the display panel 10 on which the first oleophilic region 61 is formed or to the cover window 20 on which the second oleophilic region 62 is formed. Therefore, the nonpolar liquid 50 may be prevented from leaking out of a prescribed region.

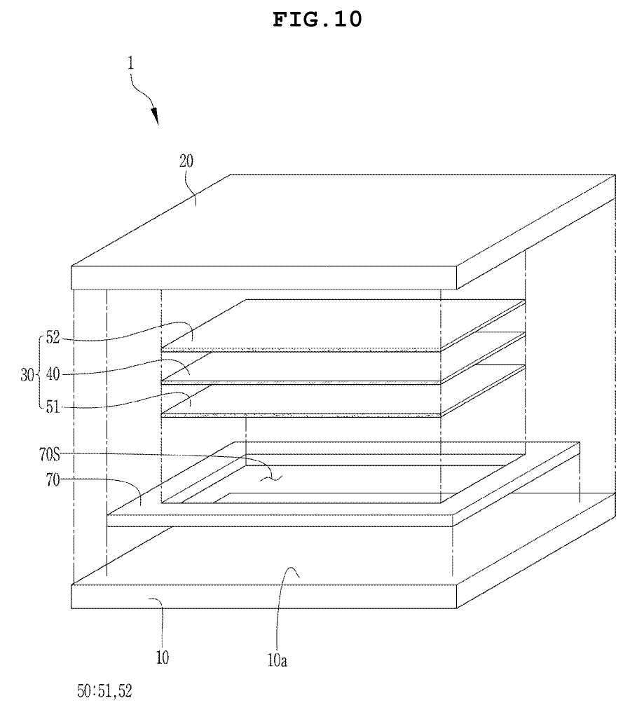

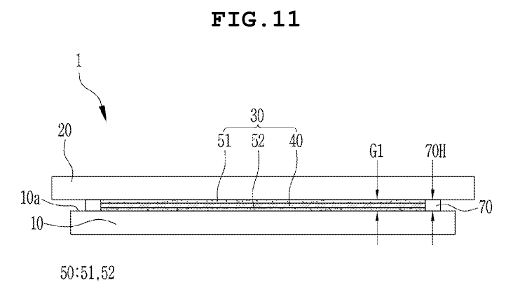

FIG. 10 is an exploded perspective view of the display device 1 including a multilayer nonpolar liquid according to the embodiment, which further includes a sealing portion 70. FIG. 11 is a cross-sectional view of the display device 1 including a multilayer nonpolar liquid shown in FIG. 10.

The display device 1 including a multilayer nonpolar liquid may further include a sealing portion 70 disposed between the display panel 10 and the cover window 20 while surrounding the multilayer nonpolar liquid layer 30. When the protruding portion 11 is present on the upper surface 10a of the display panel 10, the sealing portion 70 may be formed in the region in which the protruding portion 11 is not present. When the protruding portion 11 is not present on the upper surface 10a of the display panel 10, the sealing portion 70 may be formed to cover the entire upper surface 10a of the display panel 10.

The sealing portion 70 may be positioned between the display panel 10 and the cover window 20. The sealing portion 70 may be formed in an overall rectangular ring shape having an open central region. The sealing portion 70 may accommodate the multilayer nonpolar liquid layer 30 in an internal space 70S defined therein. The first nonpolar liquid 51, the gap control layer 40, and the second nonpolar liquid 52 may be sequentially stacked inside the sealing portion 70. Alternatively, two or more gap control layers 40 and three or more nonpolar liquids 50 may be alternately stacked inside the sealing portion 70. The sealing portion 70 surrounding the multilayer nonpolar liquid layer 30 may prevent the nonpolar liquid 50 from leaking out of the region between the display panel 10 and the cover window 20.

The height 70H of the sealing portion 70 may be the same as the size of the gap G1 between the display panel 10 and the cover window 20. The sealing portion 70 may be formed of an adhesive material to be adhered to both the display panel 10 and the cover window 20. The sealing portion 70 may be adhered to both the display panel 10 and the cover window 20, thereby maintaining a uniform gap G1 between the display panel 10 and the cover window 20.

The sealing portion 70 may be formed of an oleophilic material. Because the nonpolar liquid 50 is closely bonded to the sealing portion 70 formed of an oleophilic material, the possibility of air bubbles (e.g., AH in FIG. 4) being generated within the nonpolar liquid 50 may be minimized.

The display device 1 including a multilayer nonpolar liquid may be manufactured in a process in which the sealing portion 70 is formed on the upper surface 10a of the display panel 10, the first nonpolar liquid 51 is applied to the central region of the sealing portion 70, the gap control layer 40 is positioned on the first nonpolar liquid 51, the second nonpolar liquid 52 is applied onto the gap control layer 40, and the cover window 20 is positioned on the second nonpolar liquid 52 and the sealing portion 70.

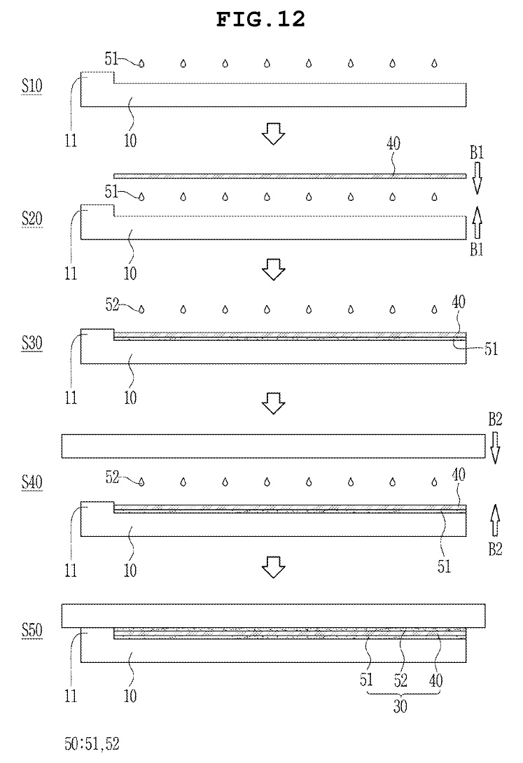

FIG. 12 is a view showing a method of manufacturing the display device 1 including a multilayer nonpolar liquid according to an embodiment.

The method of manufacturing the display device 1 including a multilayer nonpolar liquid according to the embodiment may include a step of applying a first nonpolar liquid 51 to an upper surface 10a of a display panel 10 (S10), a step of placing a gap control layer 40 on the first nonpolar liquid 51 (S20), a step of applying a second nonpolar liquid 52 onto the gap control layer 40 (S30), and a step of placing a cover window 20 on the second nonpolar liquid 52 (S40).

The step S10 of applying a first nonpolar liquid 51 may include applying the first nonpolar liquid 51 to the upper surface 10a of the display panel 10. The first nonpolar liquid 51 may be applied to a region of the display panel 10 in which a nonpolar liquid 50 is to be positioned. The first nonpolar liquid 51 may be dropped onto the upper surface 10a of the display panel 10 in the form of droplets or may be applied in a spray manner. The region in which the first nonpolar liquid 51 is positioned may be set to be wider than the active area of the display panel 10.

The step S20 of placing a gap control layer 40 may include placing the gap control layer 40 on the first nonpolar liquid 51 applied onto the display panel 10. The gap control layer 40 may be a film in the form of a thin membrane. The gap control layer 40 and the first nonpolar liquid 51 may be brought close to each other (see arrows B1), so that the first nonpolar liquid 51 may spread uniformly throughout a small gap G2 defined between the gap control layer 40 and the display panel 10.

The step S30 of applying a second nonpolar liquid 52 may include applying the second nonpolar liquid 52 onto the gap control layer 40. The second nonpolar liquid 52 may be applied to a region of the gap control layer 40 in which the nonpolar liquid 50 is to be positioned. The second nonpolar liquid 52 may be dropped onto the gap control layer 40 in the form of droplets or may be applied in a spray manner. The region in which the second nonpolar liquid 52 is positioned may correspond to the region in which the first nonpolar liquid 51 is positioned.

The step S40 of placing a cover window 20 may include placing the cover window 20 on the second nonpolar liquid 52. The cover window 20 and the second nonpolar liquid 52 may be brought close to each other (see arrows B2), so that the second nonpolar liquid 52 may spread uniformly throughout a small gap G2 defined between the gap control layer 40 and the cover window 20. In the step S40 of placing a cover window 20, the cover window 20 may be moved toward the display panel 10 until a lower surface of the cover window 20 contacts a protruding portion 11 of the display panel 10. Once the cover window 20 is placed, the first and second nonpolar liquids 51 and 52 may be positioned under and on the gap control layer 40, so that a multilayer nonpolar liquid layer 30 may be formed.

After the step S40 of placing a cover window 20 is performed, the display device 1 including a multilayer nonpolar liquid may be completely manufactured (S50).

Alternatively, the method of manufacturing the display device 1 including a multilayer nonpolar liquid may be performed in an order reverse to that described above. That is, the manufacturing method may include a step of applying the second nonpolar liquid 52 to the lower surface of the cover window 20, a step of placing the gap control layer 40, a step of applying the first nonpolar liquid 51 onto the gap control layer 40, and a step of placing the display panel.

The method of manufacturing the display device 1 including a multilayer nonpolar liquid may further include, after the step S30 of applying a second nonpolar liquid 52, a step of placing an additional gap control layer on the second nonpolar liquid 52 and a step of applying an additional nonpolar liquid onto the additional gap control layer. The step of placing an additional gap control layer and the step of applying an additional nonpolar liquid may be alternately performed one or more times.

The step of placing an additional gap control layer may include placing an additional gap control layer on the second nonpolar liquid 52. The additional gap control layer may correspond to the second gap control layer 42 shown in FIG. 5. The step of applying an additional nonpolar liquid may include applying an additional nonpolar liquid onto the additional gap control layer. The additional nonpolar liquid may correspond to the third nonpolar liquid 53 shown in FIG. 5.

The step of placing an additional gap control layer and the step of applying an additional nonpolar liquid may be alternately performed one or more times. The number of iterations may increase as the distance between the display panel 10 and the cover window 20 increases.

After the step of applying an additional nonpolar liquid is performed, the step S40 of placing a cover window 20 may be performed to complete manufacture of the display device 1 including a multilayer nonpolar liquid.

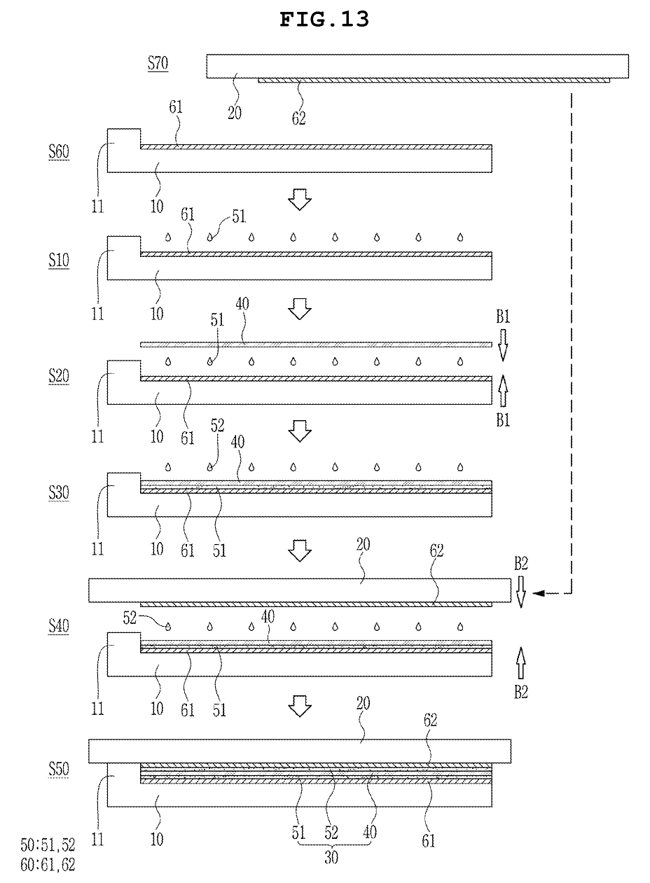

FIG. 13 is a view showing a method of manufacturing the display device 1 including a multilayer nonpolar liquid according to an embodiment, which further includes an oleophilic region 60. The manufacturing method will now be described with reference to FIG. 13 together with FIG. 12.

The method of manufacturing the display device 1 including a multilayer nonpolar liquid may further include, before the step S10 of applying a first nonpolar liquid 51 to the upper surface of the display panel 10, a step of coating an oleophilic material on the upper surface of the display panel 10 (S60), and may further include, before the step S40 of placing a cover window 20, a step of coating an oleophilic material on the lower surface of the cover window 20 (S70).

The step S60 of coating an oleophilic material on the upper surface 10a of the display panel 10 may include coating an oleophilic material in a region in which the nonpolar liquid 50 is to be positioned to form a first oleophilic region 61. The step S70 of coating an oleophilic material on the lower surface of the cover window 20 may include coating an oleophilic material in the region in which the nonpolar liquid 50 is to be positioned to form a second oleophilic region 62. The first oleophilic region 61 formed on the upper surface 10a of the display panel 10 may be in close contact with the nonpolar liquid, thereby preventing the nonpolar liquid from leaking out of the gap. The second oleophilic region 62 formed on the lower surface of the cover window 20 may be in close contact with the nonpolar liquid, thereby preventing the nonpolar liquid from leaking out of the gap. The oleophilic region 60 may be formed using a method such as spin coating or spraying.

After the first oleophilic region 61 is formed, a step of applying a first nonpolar liquid 51 (S10), a step of placing a gap control layer 40 (S20), a step of applying a second nonpolar liquid 52 (S30), and a step of placing a cover window 20 (S40) may be performed. The first nonpolar liquid 51 may be applied onto the first oleophilic region 61 on the upper surface of the display panel 10. The cover window 20 may be placed on the second nonpolar liquid 52 in a state in which the lower surface of the cover window 20 on which the second oleophilic region 62 is formed faces the second nonpolar liquid 52.

Through the above-described manufacturing method, the display device 1 including a multilayer nonpolar liquid, in which the nonpolar liquid 50 is injected into the gap in multiple layers by the gap control layer 40, may be manufactured.

As is apparent from the above description, according to an embodiment of the present disclosure, a gap control layer and a multilayer nonpolar liquid may be positioned between the display panel and the cover window and between the display panel including a protruding portion and the cover window, thereby preventing generation of air bubbles within the nonpolar liquid and improving visibility.

Although exemplary embodiments of the present disclosure have been illustrated and described in order to exemplify the principle of the present disclosure, the present disclosure is not limited to the exemplary embodiments. It will be understood that various modifications and changes can be made by those skilled in the art without departing from the spirit and scope of the disclosure as defined by the appended claims.

What is claimed is:

1. A display device including a multilayer nonpolar liquid, comprising:
a display panel;
a cover window at least partially contacting the display panel; and
a multilayer nonpolar liquid layer positioned between the display panel and the cover window,
wherein the multilayer nonpolar liquid layer comprises:
a gap control layer positioned between the display panel and the cover window, the gap control layer having a film shape;
a first nonpolar liquid positioned between the display panel and the gap control layer; and
a second nonpolar liquid positioned between the gap control layer and the cover window.

2. The display device according to claim 1, wherein the multilayer nonpolar liquid layer further comprises one or more additional gap control layers and one or more additional nonpolar liquids stacked between the second nonpolar liquid and the cover window.

3. The display device according to claim 1, wherein the gap control layer comprises an oleophilic material having compatibility with the first nonpolar liquid and the second nonpolar liquid.

4. The display device according to claim 1, wherein the first nonpolar liquid and the second nonpolar liquid are connected to each other beyond an edge of the gap control layer.

5. The display device according to claim 1, wherein the gap control layer is configured to exhibit a color, and wherein the color of the gap control layer is configured to be visually perceived in a state of being blended with a color displayed on the display panel.

6. The display device according to claim 1, wherein the gap control layer comprises a pattern, and wherein the pattern is configured to be visually perceived in a state of overlapping an image displayed on the display panel.

7. The display device according to claim 1, wherein the display panel comprises a protruding portion formed on an upper surface thereof,
wherein the cover window contacts the protruding portion, and
wherein the gap control layer is positioned between the display panel and the cover window in a region other than the protruding portion.

8. The display device according to claim 7, wherein the protruding portion contains a circuit configured to operate the display panel.

9. The display device according to claim 1, further comprising an oleophilic region comprising a coated oleophilic material, having compatibility with the first nonpolar liquid and the second nonpolar liquid, on an upper surface of the display panel and a lower surface of the cover window.

10. The display device according to claim 1, further comprising a sealing portion positioned between the display panel and the cover window so as to surround the multilayer nonpolar liquid layer.

11. The display device according to claim 1, wherein the display panel comprises:
a lower substrate;
a lower electrode layer formed on the lower substrate;
a display layer formed on the lower electrode layer, the display layer being configured to display information through movement of electrophoretic particles;
an upper electrode layer formed on the display layer; and
an upper substrate formed on the upper electrode layer.

12. A method of manufacturing a display device including a multilayer nonpolar liquid, the method comprising:
applying a first nonpolar liquid to an upper surface of a display panel;
placing a gap control layer on the first nonpolar liquid;
applying a second nonpolar liquid onto the gap control layer; and
placing a cover window on the second nonpolar liquid.

13. The method according to claim 12, further comprising:
after applying the second nonpolar liquid, placing an additional gap control layer on the second nonpolar liquid; and
applying an additional nonpolar liquid onto the additional gap control layer,
wherein placing the additional gap control layer and applying the additional nonpolar liquid are alternately performed one or more times.

14. The method according to claim 12, further comprising:
before applying the first nonpolar liquid to the upper surface of the display panel, coating an oleophilic material on the upper surface of the display panel; and
before placing the cover window, coating an oleophilic material on a lower surface of the cover window.
